(19) United States
(12) Patent Application Publication
(10) Pub. No.: US 2026/0193511 A1
(43) Pub. Date: Jul. 9, 2026

(54) DRILLING FLUIDS UTILIZING A SALT-TOLERANT LUBRICANT AND METHODS OF USE THEREFOR

(71) Applicant: Saudi Arabian Oil Company, Dhahran (SA)

(72) Inventors: Ahmet Atilgan, Houston, TX (US); Georgesha Ross, Houston, TX (US); Nicholas Osorio Labrador, Houston, TX (US); Mohamed Hamed, Houston, TX (US); Qusai Darugar, Houston, TX (US)

(73) Assignee: Saudi Arabian Oil Company, Dhahran (SA)

(21) Appl. No.: 19/010,617

(22) Filed: Jan. 6, 2025

(51) Int. Cl. C09K 8/08

(52) U.S. Cl. CPC C09K 8/08; C09K 2208/34

(57) ABSTRACT

A drilling fluid utilizing a salt-tolerant lubricant may comprise an aqueous solution comprising saltwater, seawater, brine, or combinations thereof; and a salt-tolerant lubricant comprising an organic component and an ionic liquid, wherein the ionic liquid comprises a fatty acid ester and an alkyl amine alkyl benzene sulfonate.

### FIELD

The present disclosure generally relates to drilling fluids and methods of use therefor, and particularly to lubricants therefor, such as salt-tolerant lubricants for use in a drilling fluid comprising seawater, saltwater, or brine, as explained herein. The present disclosure also generally relates to methods of forming the drilling fluids and the lubricants used therein.

### BACKGROUND

Drilling operations, for example, drilling a new wellbore for hydrocarbon extraction, include the common practice of continuously circulating a drilling fluid (alternatively known as a drilling mud) through the wellbore during the operation. The drilling fluid is pumped into the drill pipe to the bottom of the borehole, where the drilling fluid then flows upwardly through an annular space between the wellbore wall and the drill pipe and finally returns to the surface and flows out of the wellbore, where it is recovered for secondary processing. During drilling, the drilling solids, such as portions of the drilled geological formation, may be carried by the drilling fluid from at or near the bottom of the wellbore to the surface. After its return to the surface, the drilling fluid may be mechanically or chemically treated to remove captured solids and drill cuttings from the drilling fluid before recirculation back through the wellbore.

### SUMMARY

Drilling fluids are used in various drilling applications, such as rotary drilling and coiled tubing drilling applications, to complete functional tasks and ensure that the drilling operation is safe, trouble-free, and economical. One objective of a drilling fluid is the reduction of friction between the drill string and the casing or the borehole wall by acting as a lubricating medium between the metal-metal interface and the metal-mudcake interface while drilling.

Conventional water-based drilling fluids, or “muds,” have poor lubricating properties and thus have much greater coefficient of friction (COF) compared to oil-based drilling fluid systems. This is one of the major technical limitations of water-based drilling fluid systems compared to oil-based drilling fluid systems.

Moreover, saltwater may negatively interact with a variety of additives used in conjunction with drilling fluids. Particularly, saltwater may foul many typical lubricants used in the drilling fluid to assist in the reduction of the COF. Accordingly, oil-based drilling fluid systems may be preferred over fresh and salt water-based drilling fluid systems in some embodiments.

However, depending on the location of the location of the subsurface formation, availability of oleaginous fluids for the base of the drilling fluid system may vary. Particularly, environmental regulations in offshore or other locations may prevent the use of oleaginous fluids. Further, environmental regulations may also limit drilling operators' access to freshwater sources such as ponds, lakes, rivers, and aquifers. Further yet, in the case of offshore drilling, freshwater may not be practically available without costly treatment of surrounding seawater or shipment.

Accordingly, desired then are drilling fluids that are compatible with saltwater, seawater, and brine to account for these various practical and regulatory restrictions. Further yet, lubricants may be desired that are compatible or tolerant of seawater.

Consequently, provided herein are drilling fluids utilizing a salt tolerant lubricant that fulfill these aforementioned desires. Particularly, by utilizing an ionic liquid comprising a dodecyl-benzene sulfonate comprising an amine and a fatty acid ester in combination with an organic component, a salt tolerant lubricant can be formed that exhibits marked resistance to salinity in a drilling fluid. This may allow the drilling fluids to be utilized in a variety of onshore and offshore drilling situations.

In accordance with one embodiment of the present disclosure, a drilling fluid utilizing a salt-tolerant lubricant may comprise an aqueous solution comprising saltwater, seawater, brine, or combinations thereof; and a salt-tolerant lubricant comprising an organic component and an ionic liquid, wherein the ionic liquid comprises a fatty acid ester and an alkyl amine alkyl benzene sulfonate.

In accordance with another embodiment of the present disclosure, a salt tolerant lubricant may comprise an organic component; and an ionic liquid comprising an alkyl amine alkyl benzene sulfonate and a fatty acid ester.

In accordance with yet another embodiment of the present disclosure, a method of forming a salt-tolerant lubricant may comprise mixing an alkyl benzene sulfonate and an amine in a hydrocarbon solvent to form a first mixture; evaporating the hydrocarbon solvent from the first mixture to form an alkyl amine alkyl benzene sulfonate; and mixing a fatty acid ester and the alkyl amine alkyl benzene sulfonate in an organic component to form the salt tolerant lubricant.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 illustrates an offshore drilling assembly, such as for utilizing the drilling fluids described according to one or more embodiments herein;

FIG. 2 illustrates a zoomed-in view of the offshore drilling assembly of FIG. 1, particularly illustrating the circulation of the drilling fluid out of the drill bit and into the wellbore annulus, according to one or more embodiments herein;

FIG. 3 illustrates the testing of various ingredients of the lubricants described in embodiments herein alone and in various combinations;

FIG. 4 illustrates lubricity testing of a lubricant, according to embodiments herein, against a commercially available comparative lubricant, the lubricant and commercially available comparative lubricant distributed in a mock sea water;

FIG. 5 illustrates lubricity testing of another lubricant, according to embodiments herein, against the commercially available comparative lubricant, the lubricant and commercially available comparative lubricant distributed in a mock sea water;

FIG. 6 illustrates lubricity testing of another lubricant, according to embodiments herein, against a commercially available comparative lubricant, the lubricant and commercially available comparative lubricant distributed in a mock brine water.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

As previously stated, embodiments described herein generally relate to drilling fluids and methods of use therefor, and particularly to lubricants therefor, such as salt-tolerant lubricants for use in a drilling fluid comprising seawater, saltwater, or brine, as explained herein. Embodiments herein also generally relate to methods of forming the drilling fluids and the lubricants used therein.

As used throughout this disclosure, the terms “downhole” and “uphole” may refer to a position within a wellbore relative to the surface, with uphole indicating direction or position closer to the surface and downhole referring to direction or position farther away from the surface.

As described in the present disclosure, a “subsurface formation” may refer to a body of rock that is sufficiently distinctive and continuous from the surrounding rock bodies that the body of the rock may be mapped as a distinct entity. A subsurface formation is, therefore, sufficiently homogenous to form a single identifiable unit containing similar properties throughout the subsurface formation, including, but not limited to, porosity and permeability.

As used throughout this disclosure, “wellbore,” may refer to a drilled hole or borehole extending from the surface of the Earth down to the subsurface formation, including the openhole or uncased portion. The wellbore may form a pathway capable of permitting fluids to traverse between the surface and the subsurface formation. The wellbore may include at least a portion of a fluid conduit that links the interior of the wellbore to the surface. The fluid conduit connecting the interior of the wellbore to the surface may be capable of permitting regulated fluid flow from the interior of the wellbore to the surface and may permit access between equipment on the surface and the interior of the wellbore.

As used throughout this disclosure, a “wellbore wall” may refer to the interface through which fluid may transition between the subsurface formation and the interior of the wellbore. The wellbore wall may be unlined (that is, bare rock or formation) to permit such interaction with the subsurface formation or lined, such as by a tubular string, so as to prevent such interactions. The wellbore wall may also define the void volume of the wellbore.

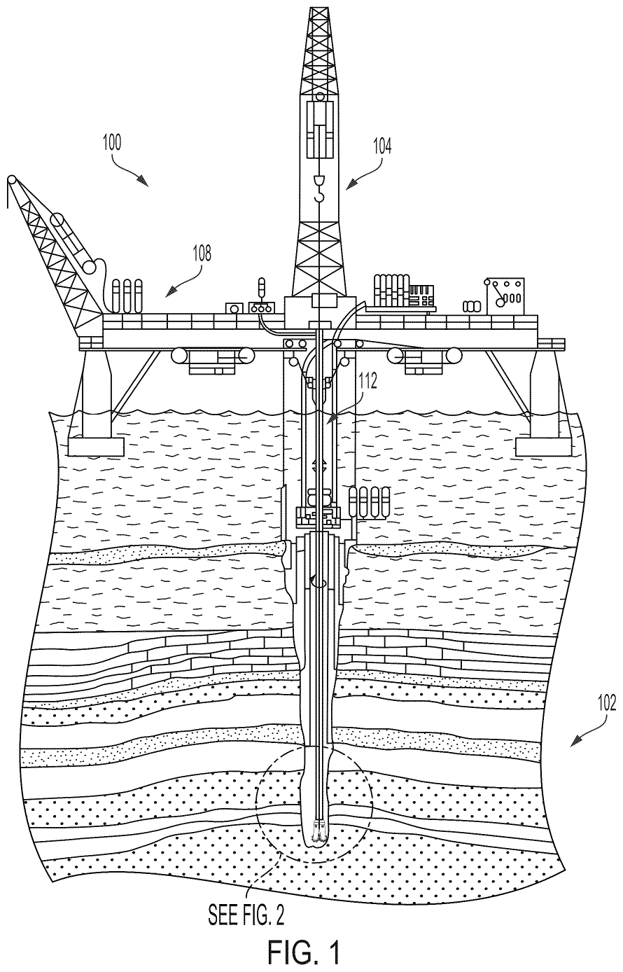

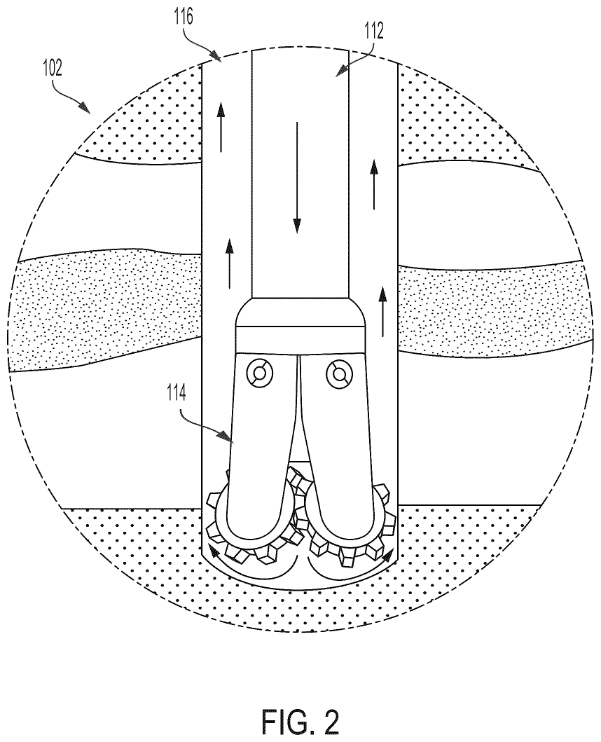

Referring initially to FIG. 1, illustrated is a drilling assembly 100 for drilling a subsurface formation 102, and particularly an offshore drilling system, such as for introducing the drilling fluid according to embodiments herein. As shown in FIG. 1, the drilling fluid may be introduced into the subsurface formation 102 through the drilling assembly 100. The drilling assembly 100 may comprise a drilling platform 108 that supports a derrick 104 having a traveling block for raising and lowering a drill string 112. The drill string may include, but is not limited to, drill pipe and/or coiled tubing, as generally known to those skilled in the art. As used throughout this disclosure, the term “drill string” refers to the combination of the drill pipe, the bottomhole assembly and any other tools used to drill the wellbore or introduce fluid into the wellbore.

As used throughout this disclosure, the term “coiled tubing” refers to a long, continuous length of pipe wound on a spool. The pipe is straightened prior to pushing into a wellbore and rewound to coil the pipe back onto the transport and storage spool. Depending on the pipe base diameter (1 in. to 4½ in.) and the spool size, coiled tubing can range from 2,000 ft to 15,000 ft (610 to 4,570 m) or greater length. A kelly may support the drill string 112 as it is lowered through a rotary table. As used throughout this disclosure, the term “kelly” refers to a long square or hexagonal steel bar with a hole drilled through the middle for a fluid path. The kelly is used to transmit rotary motion from a rotary table or kelly bushing to the drillstring 112, while allowing the drillstring to be lowered or raised during rotation. A drill bit 114 may be attached to the distal end of the drill string 112 and is driven either by a downhole motor or via rotation of the drill string from the well surface, or by both. As the bit rotates, it creates a wellbore 116 that penetrates various subsurface formations 102.

A pump (e.g., a mud pump) may circulate the drilling fluid through a feed pipe and to the kelly, which conveys the drilling fluid downhole through the interior of the drill string 112 and through one or more orifices in the drill bit 113. The drilling fluid is then circulated back to the surface via an annulus defined between the drill string 113 and the walls of the wellbore 116. As used throughout this disclosure, the term “drill pipe” refers to a tubular steel conduit fitted with special threaded ends called tool joints. The drill pipe connects the rig surface equipment with the bottomhole assembly and the bit, both to pump drilling fluid to the bit and to be able to raise, lower and rotate the bottomhole assembly and bit. At the surface, the recirculated or spent drilling fluid exits the annulus and may be conveyed to one or more fluid processing units via an interconnecting flow line. After passing through the fluid processing units, a “cleaned” drilling fluid is deposited into a nearby mud pit. While illustrated and explained as previous, it is contemplated that there may be one or more variations to the drilling assembly to account for different locations and subsurface formations, as would be understood in the art, each of which is also contemplated by this disclosure. For example, and not by way of limitation, the drilling assembly may include mooring systems, blowout prevents (BOPS), risers, and the like, such as in the case of an offshore drilling platform.

As previously stated, embodiments herein may also be directed to drilling fluids, and particularly drilling fluid utilizing a salt tolerant lubricant. The drilling fluid may comprise an aqueous solution comprising saltwater, seawater, brine, or combinations thereof, such that the drilling fluid may be regarded as a “saltwater drilling fluid”. The salt-tolerant lubricant may comprise an organic component and an ionic liquid. The organic component may comprise an oleaginous liquid, such as mineral oil. Additionally or alternatively, the organic component may comprise a hydrocarbon, an alcohol, an ester, an ether, a fatty acid, a food-grade oil, or combinations thereof. For example, and in embodiments, the organic component may comprise biodiesel, diesel, food-grade oils (such as rapeseed, olive, canola, or vegetable), polyalphaoleates (PAO), glycerol, polyethylene glycol, polyols, synthetic oils, or combinations thereof.

As used herein, an “ionic liquid” is a salt whose melting point is below 100° C. Without being limited by theory, the ionic liquids described herein may have an increased salt tolerance due to their ionic nature, providing stability advantages over traditional hydrocarbon-based lubricants in saline environments. The presence of these ionic liquids may form boundary films even on metal surfaces exposed to saline fluids, providing wear protection. Additionally hydrophobic cation layers in the ionic liquids may also resist water washout better than comparable lubricant additives.

However, not all ionic liquid structures may perform similarly as well in saline conditions as those described herein. Particularly, ionic liquids comprising hydrophilic anions like nitrate or sulfate may have diminished stability and lubricity in saline environments due to competing water interactions. This may be referred to as the ‘grease-and-cheese effect’, where the lubricant molecules of the ionic liquid coagulate with multivalent cations present in the saline environment.

In embodiments, the ionic liquid may comprise a fatty acid ester and an alkyl amine alkyl benzene sulfonate. The amine of the alkyl amine alkyl benzene sulfonate may comprise a primary amine, a tertiary amine, a quaternary amine, or combinations thereof. The amines may also comprise an aromatic amine, a cyclic amine, a protein, an amino acid, or combinations thereof, such as but not limited to pyridine, pyrimidine and quinoline derivatives, as well as pyrrolidine, pyrole, imidazole, piperidene, piperazine, purine, indole, bipiperidine, or combinations of any of the previous. Further, the sulfonate component of the alkyl amine alkyl benzene sulfonate may comprise any variation of a sulfonate molecule having aliphatic groups, aromatic groups, or both.

For example, and in embodiments, the alkyl amine alkyl benzene sulfonate may be dodecyl-benzene sulfonate triethylamine (DBS-TEA). The fatty acid ester may comprise a monoester, diester, trimester, tetraester, polyester, or combinations thereof. The monesters be a methyl, ethyl, propyl, butyl, pentyl, hexyl, and heptyl monoester. The ester groups may also comprise an alkyl or sub-alkyl group connected to an oxygen or carbon atom. In embodiments, the fatty acid may be fatty acid methyl ester (FAME), fatty acid ethyl ester, fatty acid propyl ester, fatty acid butyl ester, fatty acid pentyl ester (FAPE), fatty acid hexyl ester, or combinations thereof.

In embodiments, the drilling fluid and/or the salt-tolerant lubricant may comprise one or more additional additives to enhance the properties and characteristics of the drilling fluid and/or the salt-tolerant lubricant. For example, and in embodiments, the drilling fluid and/or the salt-tolerant lubricant may comprise an emulsifier. Additionally, the drilling fluid and/or the salt-tolerant lubricant may further comprises additives including, but not limited to, fluid-loss control additives, viscosifiers (viscosity control agents), alkali compounds, friction reducers, or combinations thereof. The water-based drilling fluid system may also optionally include pH buffers, electrolytes, glycols, glycerols, dispersion aids, corrosion inhibitors, defoamers, and other additives or combinations thereof.

In embodiments, the emulsifier may comprise ethylene glycol monobutyl ether (EGMB). Additionally or alternatively, the emulsifier may comprise polyethylene glycol, polypropylene glycol, polyvinyl alcohol, Ethylene glycol monoethyl ether (EGEE), Diethylene glycol monobutyl ether (DEGBE), Propylene glycol monobutyl ether (PGBE), Dipropylene glycol monobutyl ether (PGBE), ethoxylated alcohols, isodecyl alcohol ethoxylates, polysorbates, sodium dodecyl sulfates, any fatty acid salts, proteins, aromatic solvents, or copolymers or mixtures thereof.

In embodiments, the salt-tolerant lubricant may comprise from 0.1 wt. % to 99 wt. % organic component, such as from 0.1 wt. % to 2 wt. %, from 2 wt. % to 10 wt. %, from 10 wt. % to 50 wt. %, from 50 wt. % to 70 wt. %, from 70 wt. % to 75 wt. %, from 75 wt. % to 90 wt. %, from 90 wt. % to 99 wt. %, or combinations of the previous ranges or smaller ranges therein, such as from 2 wt. % to 75 wt. % organic component.

In embodiments, the salt-tolerant lubricant may comprise from 0.25 wt. % to 15 wt. % alkyl amine alkyl benzene sulfonate, such as from 0.25 wt. % to 1 wt. %, from 1 wt. % to 5 wt. %, from 5 wt. % to 8 wt. %, from 8 wt. % to 10 wt. %, from 10 wt. % to 12 wt. %, from 12 wt. % to 15 wt. %, or combinations of the previous ranges or smaller ranges therein, such as from 0.25 wt. % to 10 wt. %.

The salt-tolerant lubricant may comprise from 0.1 wt. % to 99 wt. % fatty acid ester, such as from 0.1 wt. % to 0.4 wt. %, from 0.4 wt. % to 1 wt. %, from 1 wt. % to 10 wt. %, from 10 wt. % to 15 wt. %, from 15 wt. % to 40 wt. %, from 40 wt. % to 80 wt. %, from 80 wt. % to 95 wt. %, or combinations of the previous ranges or smaller ranges therein, such as from 0.4 wt. % to 15 wt. % fatty acid ester.

The salt-tolerant lubricant may comprise from 0.01 wt. % to 50 wt. % emulsifier, such as from 0.01 wt. % to 0.05 wt. %, from 0.05 wt. % to 1 wt. %, from 1 wt. % to 2 wt. %, from 2 wt. % to 3 wt. %, from 3 wt. % to 10 wt. %, from 10 wt. % to 40 wt. %, from 40 wt. % to 50 wt. %, or combinations of the previous ranges or smaller ranges therein, such as from 0.05 wt. % to 3 wt. % emulsifier.

The salt-tolerant lubricant may comprise fatty acid ester to organic component in a ratio for 1:1000 to 1000:1, such as from 1:1000 to 1:100, from 1:100 to 1:10, from 1:10 to 1:5, from 1:5 to 1:3, from 1:3 to 1:1, from 1:1 to 1:3, from 1:3 to 1:5, from 1:5 to 1:10, from 1:10 to 1:100, from 1:100 to 1:1000 or combinations of the previous ranges or smaller ranges therein, such as from 1:10 to 10:1, as measured by the weight percent fatty acid ester to organic component.

In embodiments, the drilling fluid may comprise from 0.05 wt. % to 50 wt. % of any additional additive, such as from 0.05 wt. % to 1 wt. %, from 1 wt. % to 2 wt. %, from 2 wt. % to 3 wt. %, from 3 wt. % to 10 wt. %, from 10 wt. % to 40 wt. %, from 40 wt. % to 50 wt. %, or combinations of the previous ranges or smaller ranges therein, such as from 0.05 wt. % to 3 wt. % additive.

The drilling fluid may comprise from 0.025 vol. % to 10 vol. % salt-tolerant lubricant, such as from 0.025 vol. % to 0.1 vol. %, from 0.1 vol. % to 0.25 vol. %, from 0.25 vol. % to 0.5 vol. %, from 0.5 vol. % to 0.75 vol. %, from 0.75 vol. % to 1 vol. %, from 1 vol. % to 1.25 vol. %, from 1.25 vol. % to 1.5 vol. %, from 1.5 vol. % to 3 vol. %, from 3 vol. % to 5 vol. %, from 5 vol. % to 10 vol. %, or any combination of the previous ranges or smaller range therein, such as from 0.25 vol. % to 1.25 vol. % ionic liquid. The drilling fluid may also comprise a balance aqueous solution, such as from 45 vol. % to 97.975 vol. % aqueous solution. The aqueous solution may comprise greater than 5000 ppm dissolved solids, such as from 5000 ppm to 50,000 mg/L dissolved solids.

As previously stated, embodiments herein also generally relate to methods of forming the drilling fluids and the salt tolerant lubricants used therein. For example, and in embodiments, a method of forming the salt tolerant lubricant, and in particular the alkyl amine alkyl benzene sulfonate, may comprise mixing an alkyl benzene sulfonate and an amine in an alcohol solvent to form a first mixture.

The alkyl benzene sulfonate and the amine may be any of the alkyl benzene sulfonates or the amines previously described. The alcohol solvent may comprise any alcohol known in the art, such as any alcohol containing from 1 carbon atom to six carbon atoms in the chain/molecule, including but not limited to methanol, ethanol, propanol, butanol, pentanol, and hexanol. The method may further comprise evaporating the alcohol solvent from the first mixture to form the alkyl amine alkyl benzene sulfonate.

To form the fatty acid ester, the method may further comprise mixing a fatty acid with sulfuric acid in additional alcohol solvent to form a second mixture. The fatty acid may be any fatty acid known in the art, such as any fatty acid containing greater than 10 carbon atom chains, such as C₁₀ to C₁₈ hydrocarbon-based fatty acids, as well as C₁₈₊ hycarbon-based fatty acids containing one or more carbon-carbon double or triple bonds in the chain, or one or more branches in the chain.

The method may further comprise evaporating unreacted alcohol solvent from the second mixture to form a catalyzed product; filtering volatile species from the catalyzed product to form the fatty acid ester; and mixing the fatty acid ester and the alkyl amine alkyl benzene sulfonate in an organic component to form the salt tolerant lubricant.

In embodiments, filtering the volatile species from the catalyzed product to form the fatty acid ester may comprise mixing the catalyzed product with a solution of a water immiscible organic solvent, such as ethyl acetate, but alternatively or additionally dichloromethane, chloroform, diethyl esters, benzene, or toluene. Filtering the volatile species may also comprise progressively washing the catalyzed product with aqueous solutions of sodium bicarbonate (or any other basic neutralizing agent), sodium hydroxide, brine, and water; filtering the washed catalyzed product by exposing the washed catalyzed product to sodium sulfate and additional ethyl acetate; and evaporating the filter catalyzed product to form the fatty acid ester. The filtering of the volatile species from the catalyzed product to form the fatty acid ester may also be conducted in at least one extraction funnel.

Additionally, or alternatively, the method of forming the salt-tolerant lubricant may further comprise mixing an emulsifier with the fatty acid ester, the organic component, and the alkyl amine alkyl benzene sulfonate. The method may also comprise mixing an aqueous solution and/or one or more additional additives with the fatty acid ester, the organic component, and the alkyl amine alkyl benzene sulfonate to form the drilling fluid.

As previously stated, embodiments herein are also directed to methods of utilizing the drilling fluid and the salt tolerant lubricant. Particularly, in at least one embodiment, a method of drilling a well may comprise introducing the drill string 112 into the wellbore 116, the drill string comprising the drill bit 114 attached to a distal end of the drill string 112; and circulating the drilling fluid through the drill bit 114 and up through the wellbore annulus defined between an exterior of the drill string 112 and the wellbore 116, thereby lubricating the drill bit 114. The drilling fluid may be any of the drilling fluids previously described.

### Examples

To determine the tolerance of the lubricants described herein to saline solutions, various salt-tolerant lubricants were formed and tested. To form the alkyl amine alkyl benzene sulfonate, dodecyl benzene sulfonate and triethylamine were added to isopropanol and stirred for 30 minutes. After addition of the triethylamine, the mixture was observed to warm. The mixture was then left to cool back to room temperature. Volatiles in the reaction mixture were evaporated using a rotavap and the resultant DBS-TEA liquid was collected, the results of which were confirmed by NMR spectrum analysis.

To form the fatty acid ester, a mixture of C₁₂-C₁₄ fatty acids were dissolved separately in excess alcohol solvents of methanol and pentanol with sulfuric acid added into the solution as a catalyst.

The reaction was conducted in a reaction vessel with a condenser extension and refluxed overnight. The reaction vessel was then transferred to a rotovap to evaporate the excess alcohol. The crude product was then sequentially exposed to solutions of ethyl acetate, sodium bicarbonate, sodium hydroxide, brine, and water in an extraction funnel. The resulting product was then poured into dry sodium sulfate and filtered with the addition of fresh ethyl acetate. The volatiles were then evaporated in a rotovap under high vacuum and temperature to form the resulting fatty acid methyl ester (FAME) and fatty acid pentyl ester (FAPE), the results of which were confirmed by NMR spectrum analysis. Two salt tolerant lubricants were then made by mixture of the various components with FAME or FAPE, the composition and amounts of which are shown below in Table 1.

TABLE 1
Lubricant Composition

| | | |
|---|---|---|
| Ingredient | Amount (g) | Wt. % Ingredient |

Lubricant-1 (FAME)

| | | |
|---|---|---|
| Mineral oil | 2.000 | 73.9 |
| DBS-TEA | 0.250 | 9.2 |
| Methyl Ester | 0.400 | 14.8 |
| EGMB | 0.057 | 2.1 |

Lubricant-2 (FAPE)

| | | |
|---|---|---|
| Mineral oil | 2.000 | 73.9 |
| DBS-TEA | 0.250 | 9.2 |
| Pentyl Ester | 0.400 | 14.8 |
| EGMB | 0.057 | 2.1 |

A Fann Model 212 Combination Extreme Pressure Lubricity Tester was then utilized to conduct lubricity testing with the lubricants, as explained below. The lubricity tester was calibrated by following the calibration procedure described in the user manual, with appropriate cleaning between steps. Each of the lubricants tested was exposed either to a saltwater formulated to model Arabian Gulf sea water or a saltwater formulated to model a brine water, shown below in Table 2.

TABLE 2
Composition of Sea Water and Brine Water

| | |
|---|---|
| Salt | Amount (g/L) |

Mock Sea Water

| | |
|---|---|
| NaCl | 41.72 |
| KCl | 1.13 |
| MgCl₂ | 8.26 |
| CaCl₂ | 1.71 |
| NaHCO₃ | 0.21 |
| Na₂SO₄ | 6.12 |

Mock Brine Water

| | |
|---|---|
| NaCl | 100 |

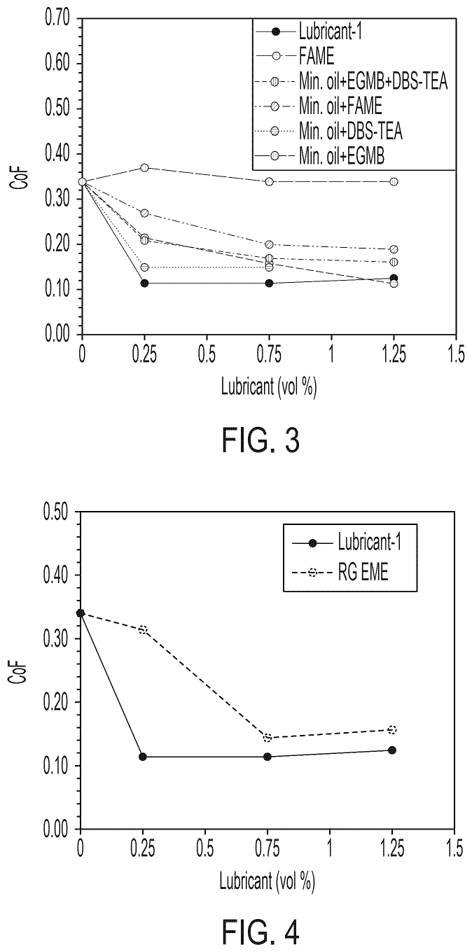

To determine the impact of synergy of the ingredients of the lubricant, various components were tested alone and in combination at varying concentrations in the mock sea water, as shown in FIG. 3. Particularly, none of the mineral oil, alkyl amine alkyl benzene sulfonate, and the emulsifier impacted the coefficient of friction (COF) of the drilling fluid, whereas the fatty acid esters only impacted the COF only at high concentrations. Further, while addition of fatty esters or the alkyl amine alkyl benzene sulfonate was shown to improve the COF, exhibiting at least some synergy between the components, the most significant synergy was observed when all ingredients of the lubricant were present (lubricant-1).

To determine the anti-cheesing and stability resistance of the lubricant, a 10 vol. % mixture of Lubricant-1 was mixed with a 1 wt. % CaCl₂) aqueous solution, with Radiagreen EME salt used as a comparative commercially available salt-tolerant lubricant. H₂S was added as a scavenger compound. The two fluids' pH's were adjusted identically to a basic pH and then filtered through a filter paper. The results for the test are shown in Table 3, with Lubricant-1 showing much less cheesing and scavenger residue, indicating Lubricant-1's stability in saline solutions.

TABLE 2
Cheesing and Scavenger Test Results

| | Cheesing test | Scavenger test |
|---|---|---|
| Lubricant | residue (g) | residue (g) |
| RG EME | 2.02 | 2.75 |
| Lubricant-1 | 0.75 | 1.64 |

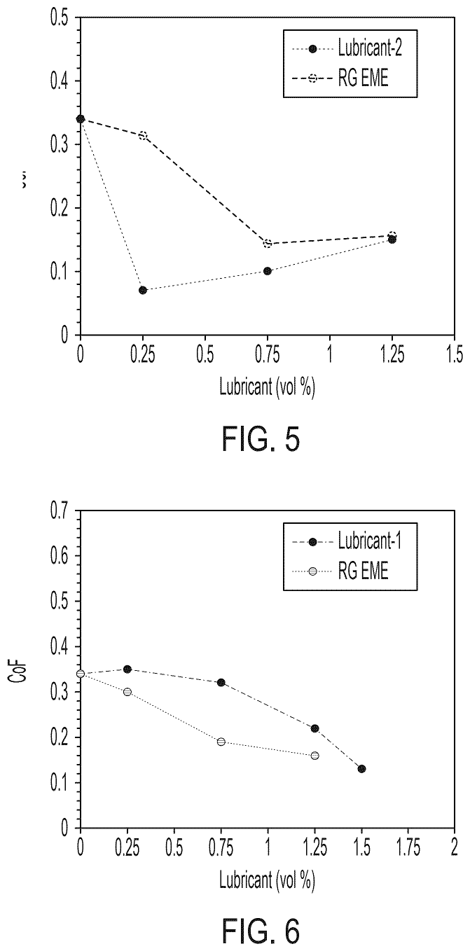

After the lubrication, anti-cheesing, and stability properties of the lubricant were confirmed in saline conditions, Lubricants 1 and 2 were then tested as compared to Radiagreen EME salt. Radiagreen EME salt is stating as having greater than 60% wt. % fatty esters and a remaining 40 wt. % specialties. The results are shown in FIGS. 4-6, with FIGS. 4 and 5 illustrating Lubricants 1 and 2 in the mock sea water, and FIG. 6 illustrating Lubricant-1 in the mock brine water.

As shown in FIGS. 4 and 5, Lubricants 1 and 2 exhibited increased performance over the Radiagreen lubricant at all concentrations. The greatest increase in performance (and the highest performance of the lubricant in general) was observed at a lubricant concentration of 0.25 vol. %, indicating the lubricants herein may be used in much lower concentrations over the commercially available alternatives while still providing greater impact. Moreover, the Lubricants, and in particular Lubricant-1, exhibited comparable COF performance to the Radiagreen lubricant in the mock brine water.

It is also noted that recitations herein of “at least one” component, element, etc., should not be used to create an inference that the alternative use of the articles “a” or “an” should be limited to a single component, element, etc. The singular forms “a,” “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.” It is noted that the use of the terms “having” or “including”, or grammatical variations thereof, in this disclosure should also be interpreted in like manner as the more commonly used open-ended preamble term “comprising”.

As used in this disclosure, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present embodiments herein in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present embodiments including, but not limited to, embodiments defined in the appended claims. More specifically, although some aspects of the present embodiments are identified herein as preferred or particularly advantageous, it is contemplated that the present embodiments is not necessarily limited to these aspects.

What is claimed is:

1. A drilling fluid utilizing a salt-tolerant lubricant, the drilling fluid comprising:
an aqueous solution comprising saltwater, seawater, brine, or combinations thereof; and
a salt-tolerant lubricant comprising an organic component and an ionic liquid, wherein the ionic liquid comprises a fatty acid ester and an alkyl amine alkyl benzene sulfonate.

2. The drilling fluid of claim 1, wherein the amine of the alkyl amine alkyl benzene sulfonate comprises a primary amine, a tertiary amine, a quaternary amine, or combinations thereof.

3. The drilling fluid of claim 1, wherein the alkyl amine alkyl benzene sulfonate is dodecyl-benzene sulfonate triethylamine (DBS-TEA).

4. The drilling fluid of claim 1, wherein the organic component comprises a hydrocarbon, an alcohol, an ester, an ether, a fatty acid, or combinations thereof.

5. The drilling fluid of claim 4, wherein the organic component is mineral oil.

6. The drilling fluid of claim 1, wherein the fatty acid ester is fatty acid methyl ester (FAME), fatty acid ethyl ester, fatty acid propyl ester, fatty acid butyl ester, fatty acid pentyl ester (FAPE), fatty acid hexyl ester, or combinations thereof.

7. The drilling fluid of claim 1, wherein the ionic liquid further comprises an emulsifier.

8. The drilling fluid of claim 7, wherein the emulsifier comprises ethylene glycol monobutyl ether (EGMB).

9. The drilling fluid of claim 1, wherein:
the salt-tolerant lubricant further comprises an emulsifier comprising ethylene glycol monobutyl ether (EGMB);
the organic component comprises mineral oil;
the alkyl amine alkyl benzene sulfonate comprises dodecyl-benzene sulfonate triethylamine (DBS-TEA); and
the fatty acid ester comprises fatty acid methyl ester (FAME), fatty acid ethyl ester, fatty acid propyl ester, fatty acid butyl ester, fatty acid pentyl ester (FAPE), fatty acid hexyl ester, or combinations thereof.

10. The drilling fluid of claim 1, wherein the salt-tolerant lubricant comprises:
from 2 wt. % to 75 wt. % organic component;
from 0.25 wt. % to 15 wt. % alkyl amine alkyl benzene sulfonate; and
from 0.4 wt. % to 95 wt. % fatty acid ester.

11. The drilling fluid of claim 1, wherein the aqueous solution comprises greater than 5000 ppm dissolved solids.

12. The drilling fluid of claim 1, wherein the drilling fluid comprises:
from 0.05 vol. % to 10 vol. % lubricant; and
the balance aqueous solution.

13. A method of drilling a well utilizing the drilling fluid of claim 1, the method comprising:
introducing a drill string into a wellbore, the drill string comprising a drill bit attached to a distal end of the drill string; and
circulating the drilling fluid through the drill bit and up through a wellbore annulus defined between an exterior of the drill string and the wellbore, thereby lubricating the drill bit.

14. A method of forming a salt-tolerant lubricant, the method comprising:
mixing an alkyl benzene sulfonate and an amine in an alcohol solvent to form a first mixture;
evaporating the alcohol solvent from the first mixture to form an alkyl amine alkyl benzene sulfonate; and
mixing a fatty acid ester and the alkyl amine alkyl benzene sulfonate in an organic component to form the salt tolerant lubricant.

15. The method of claim 14, wherein:
the amine of the alkyl amine alkyl benzene sulfonate comprises triethylamine, such that the alkyl amine alkyl benzene sulfonate is dodecyl-benzene sulfonate triethylamine (DBS-TEA);
the fatty acid ester comprises fatty acid methyl ester, fatty acid pentyl ester, or both; and
the organic component comprises mineral oil.

16. The method of claim 14, further comprising mixing an emulsifier with the fatty acid ester, the organic component, and the alkyl amine alkyl benzene sulfonate.

17. The method of claim 14, wherein the emulsifier comprises ethylene glycol monobutyl ether (EGMB).

18. A salt tolerant lubricant, the salt tolerant lubricant comprising:
an organic component; and
an ionic liquid comprising an alkyl amine alkyl benzene sulfonate.

19. The salt tolerant lubricant of claim 18, wherein the ionic liquid further comprises a fatty acid ester.

20. The salt tolerant lubricant of claim 19, wherein:
the organic component comprises a hydrocarbon, an alcohol, an ester, an ether, a fatty acid, or combinations thereof;
the alkyl amine alkyl benzene sulfonate is dodecyl-benzene sulfonate triethylamine (DBS-TEA); and
the fatty acid ester is fatty acid methyl ester (FAME), fatty acid ethyl ester, fatty acid propyl ester, fatty acid butyl ester, fatty acid pentyl ester (FAPE), fatty acid hexyl ester, or combinations thereof.
